(19) United States
(12) Patent Application Publication
(10) Pub. No.: US 2025/0358467 A1
(43) Pub. Date: Nov. 20, 2025

(54) DETERMINING VIDEO RESOLUTION FOR VIDEO STREAMING

(71) Applicants: Beijing Zitiao Network Technology Co., Ltd., Beijing (CN); Lemon Inc., Grand Cayman (KY)

(72) Inventors: Liyang Sun, Los Angeles, CA (US); Shenglan Huang, Culver City, CA (US); Pengcheng Chen, Beijing (CN); Zhendong Zhong, Beijing (CN); Mingkui Liu, Culver City, CA (US); Qian Ma, Beijing (CN)

(21) Appl. No.: 18/919,837

(22) Filed: Oct. 18, 2024

Related U.S. Application Data
(63) Continuation of application No. PCT/CN2024/093679, filed on May 16, 2024.

(51) Int. Cl. H04N 21/2662; H04N 21/2343; H04N 21/258

(52) U.S. Cl. CPC H04N 21/2662; H04N 21/234363; H04N 21/25891

(57) ABSTRACT

Example computer-implemented methods and systems for determining video resolution for video streaming are disclosed. One example method includes determining a preference of a user for a particular video playback characteristic; determining, based on the determined preference of the user and for each version of a video, a return of interest (ROI), wherein each version of the video has a particular resolution and bitrate; determining, based on the ROI, a version of the video to provide to a device of the user; and providing the corresponding version of the video to the device of the user.

### CLAIM OF PRIORITY

This application is a continuation of, and claims priority to International Application No. PCT/CN2024/093679, filed May 16, 2024, the contents of which are incorporated herein by reference in their entirety.

### BACKGROUND

This specification relates to determining video resolution for video streaming.

To satisfy preferences of different users of a video streaming service, as well as the capabilities of user devices and associated computer networks, a video can be transcoded into multiple resolutions and video bitrates. Higher network bandwidth and/or higher user device performance may be needed to support the playback of videos with higher bitrates. On the other hand, lower video bitrate can lead to smoother but relatively lower resolution video playback.

### SUMMARY

This specification is generally directed to techniques for determining playback characteristics for a video to be provided for playback on a device of a user. One example method includes determining a preference of a user for a particular playback characteristic among multiple playback characteristics. The preference can be represented as a binary classification, e.g., preference for the playback characteristic (e.g., video playback quality/resolution) or not. The preference can also be represented by a value, e.g., between 0 and 1, represented a degree of sensitivity to the playback characteristic where the closer the value to 1 the greater the preference. The playback characteristics can include a video resolution and/or bitrate, video stalling, first frame delay etc. For example, differences in video resolution can result in blurring or pixelation of the video, which affects the user's perceived video quality. Video stalling, for example due to rebuffering, can cause pauses or freezes during playback. First frame delay can be the result of a longer time needed to download video data to initiate playback. In this specification, a preference for a particular minimum resolution or resolution/bitrate pair, during video streaming will be referred to as a resolution preference. Additionally, a preference to reduce stalling and/or first frame delay during video streaming will be referred to a as smoothness preference. A return of interest (ROI) of the user is determined based on the preference. A resolution of a video for playback on a device of the user is determined based on the ROI of the user. The ROI represents a total interest of the user in the particular video playback. Using the ROI, the determined resolution of the video can more closely match the determined preference of the user. After determining the particular resolution to use, the corresponding version of the video is provided to the user device, e.g., to be included in a video feed of client software on the user device.

In general, one innovative aspect of the subject matter described in this specification can be embodied in methods that include the actions of determining a preference of a user for a particular video playback characteristic; determining, based on the determined preference of the user and for each version of a video, a return of interest (ROI), wherein each version of the video has a particular resolution and bitrate; determining, based on the ROI, a version of the video to provide to a device of the user; and providing the corresponding version of the video to the device of the user. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. The techniques described in this specification can lead to better overall video playback experience for the users by more accurately matching the video playback characteristics with the user preferences. The enhanced user experience can result in longer streamed video duration and/or longer watch time of videos of a video streaming system on user devices.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

Implementations of the present disclosure are described in further detail herein with reference to an example use case. The example use case includes determining a resolution of a video to be downloaded for playback on a device of a user. It is contemplated, however, that implementations of the present disclosure can be realized with any appropriate use case.

### BRIEF DESCRIPTION OF DRAWINGS

FIG. 1 illustrates an example system for video streaming.

FIG. 2 illustrates an example process of determining a resolution of a video to be downloaded for playback on a device of a user.

FIG. 3 illustrates an example process of determining video resolution for video streaming.

FIG. 4 is a schematic illustration of example computer systems that can be used to execute implementations of the present disclosure.

Like reference numbers and designations in the various drawings indicate like elements.

### DETAILED DESCRIPTION

Users of a video streaming service can have various preferences towards different playback characteristics. The video streaming service, can be for example, an online social media system or platform that provides video content to account holder, e.g., as part of a video feed. The user preferences can include a preference for higher video resolution (e.g., perceived video quality) over video smoothness (e.g., stalling or freezing instances during playback). In this case, a lower video bitrate version of a video file may not be selected for video playback on the user's device even though video rebuffering/stall may occur during video playback of the high resolution video, e.g., due to characteristics of the user's device or network performance. On the other hand, another user may prefer video smoothness to video resolution. For example, some users may stop watching a video shortly after video rebuffering or if a long video delay in first frame playback occurs. For such users, a lower resolution and/or lower bitrate version of the video file may result in a better user experience than a higher resolution version of the video.

This specification relates to methods and systems for improving user experience of video playback during streaming of video content, for example, by selecting a resolution of the video that more closely aligns with the user preference between video resolution and video smoothness, based, for example, on the bandwidth of the user's network and available resolutions of transcoded versions of the video files to be provided to the user device. In some cases, the user preference can be determined from the video playback history associated with the user. A return of interest (ROI) value associated with the preference of the user can be determined for each available resolution of a transcoded video. The ROI represents a total interest of the user in the particular video playback. As discussed below, the ROI at a particular resolution can be calculated based a combination of a perceived video quality provided by the given resolution, a video smoothness, and network resources needed to deliver the video content at the given resolution. The transcoded version of the video corresponding to the resolution that results in the largest ROI can then be selected for providing to the user device for playback.

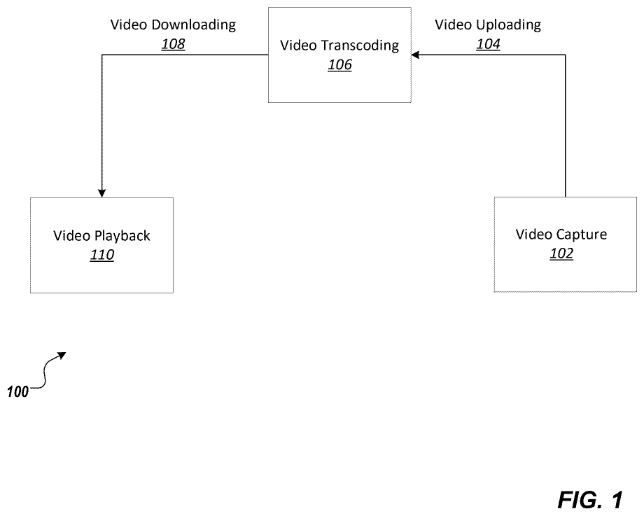

FIG. 1 illustrates an example system 100 for video streaming. At 102, a user, for example, a first user, records or captures a video using a video recording device such as a camera of a user device. The user device can be any Internet-connected computing device, e.g., a laptop or desktop computer, a smartphone, or an electronic tablet. The user device can be connected to the Internet through a mobile network, through an Internet service provider (ISP), or otherwise. Each user device is configured with software, which will be referred to as a client or as client software, that in operation can access the streaming service so that a user can interact with the streaming service. For example, the user can use the client software to upload video content to the streaming service as well as receive videos from the streaming service. The client software can be a specific application of the streaming service installed on the user device. The streaming service can be, for example, an online social media platform.

In some implementations, the client software provides a user interface for interacting with the streaming service. The user interface can include receiving data from the streaming service for presenting a feed of videos that the user can interact with. For example, the user can scroll up or down to switch between videos in the feed as well as interact with individual videos, e.g., by posting comments about the video, sharing the video, or expressing approval, e.g., liking the video.

In some implementations, the video content provided by the streaming service to user devices are short-form videos. Short-form videos are videos that are typically less than 90 seconds in length. In some implementations, short-form videos have lengths of between 15 and 90 seconds. By contrast, long-form videos typically have lengths of at least 3 minutes.

At 104, the first user uploads the video to the streaming service. The streaming service can include many different components for transcoding received video content, storing the transcoded version, and selecting video content to provide to recipient users. The streaming service can also include for example, a content delivery network (CDN) that includes a geographically distributed group of devices that provide content to end user devices. For clarity, FIG. 1 focuses only on the transcoding of uploaded video files and subsequent delivery to user device.

At 106, the server transcodes the obtained video file to generate multiple versions of the video file, each having a particular resolution/bitrate combination. Example resolutions of the transcoded videos can include 540p, 720p, and/or 1080p, where “p” stands for “progressive scan,” a scan mode of a transcoded video, as well as 2 k and 4 k, where “k” refers to an approximate number of horizontal pixels. Different resolutions can have the same bitrate, e.g., 2.4 Mbps, or different bitrates. Additionally, different versions can have the same resolution but different bitrates. The collection of transcoded versions for a given video can be referred to as a video ladder. Once the video has been transcoded into multiple versions, the versions are stored, e.g., as video ladders in a video storage. The video storage may be a distributed storage among multiple storage devices. Further, the video storage may be replicated in multiple locations such that multiple copies of the versions are stored, e.g., in multiple datacenters. In some implementations, sets of video ladders are cached in different devices of the CDN.

At 108, a particular transcoded version of the video from the multiple transcoded videos is selected and provided to a device of a user, for example, a second user. The video can be provided to the device of the second user, for example, in response to a request for video content received by the streaming service. As described below, the system of the streaming service determines a particular version of each video to provide to the device, e.g., for playback. At 110, the device of the second user plays back the video content.

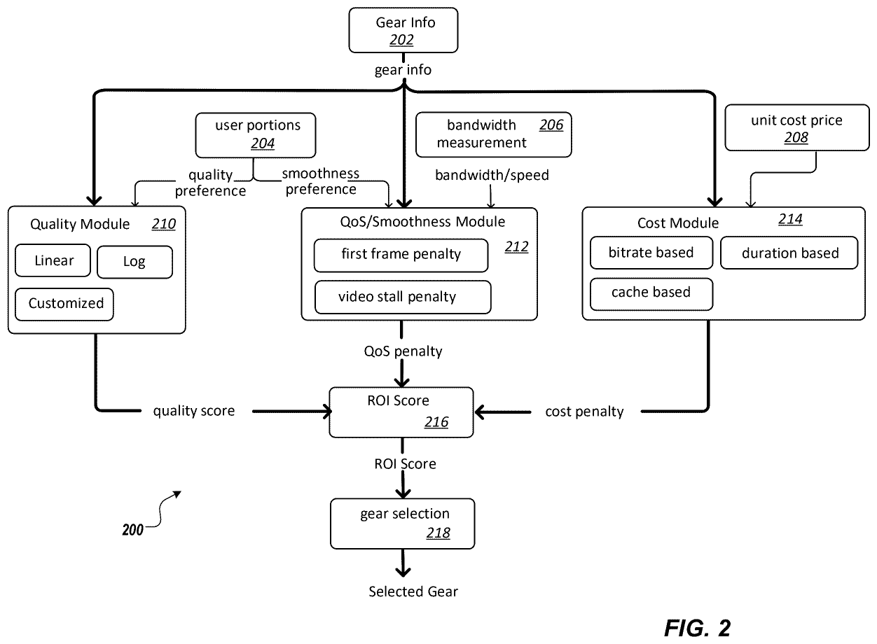

FIG. 2 illustrates an example process 200 of determining a resolution of a video to be downloaded for playback on a device of a user. For convenience, the process 200 will be described as being performed by a system of one or more computers, located in one or more locations, and programmed appropriately in accordance with this specification. For example, a streaming system, e.g., an online social media platform, appropriately programmed, can perform the process 200.

At 202, the system obtains information about the different resolution/bitrate versions of the video, e.g., as transcoded by video transcoding 106. This set of versions can be referred to as a video ladder, bitrate set, or video “gears”. The information can include information regarding all available resolutions and bitrates of the versions of the video. As shown in FIG. 2, the information can be input to a quality module, a quality of service (QoS)/Smoothness module, and a resource usage module in FIG. 2.

At 204, the system obtains a user portrait associated with a user. In some cases, the user can be the second user in FIG. 1 that is provided with the video for playback. Each user's user portrait describes the video streaming preference determined for the user. For example, the user portrait can include a preference of the user between video resolution and video smoothness. For example, when the user portrait indicates the preference is video resolution preferred, the user prefers a higher resolution or high bitrate playback of received video content even under conditions in which a lower resolution or bitrate may have less stalling. By contrast, when the user portrait indicates the preference is video smoothness preferred, the user prefers smoothness of the video playback, e.g., minimizing stalling, even when that requires a lower video resolution or bitrate to achieve.

In some implementations, the preference identified in the user portrait can be represented by a real number within a range, describing a degree on a continuum to which a user prefers resolution or smoothness. For example, the value of the preference of the user portrait can be a value between 0 and 1 with 1 representing resolution is most preferred (and least video smoothness preferred), 0 representing resolution is least preferred (and video smoothness is most preferred), and 0.5 representing no preference between video resolution and video smoothness during video playback.

In some implementations, the user portrait can be generated using historical video playback data of the user. For example, the value of the user portrait of the user can be determined as indicating the user prefers video resolution if the user spends more time playing videos with high resolution playback during a predetermined period of time, even with playback interrupts (e.g., video rebufferings or video stalls). In contrast, the value of the user portrait of the user can be determined as indicating that the user prefers video smoothness if the user spends more time playing videos without playback interrupts (e.g., video rebufferings or video stalls) during a predetermined period of time, even with respect to videos having lower resolutions or bitrates. Similarly, user playback data indicating that the user quickly scrolls away from video playback that is either low resolution or has stalling provides additional preference information used to determined the value of the user portrait.

In some other implementations, the user portrait can be generated in real time based on input from the user during video playback. For example, the system can generate the user portrait based on the user's real time choice between quality preferred, smoothness preferred, and neutral.

At 206, the system obtains a bandwidth measurement associated with the user's network used for streaming the video. The bandwidth measurement can correspond to the network speed of the user's network between the system and the user device. As shown in FIG. 2, the bandwidth measurement can be an input to the QoS/Smoothness module.

At 208, the system obtains resource usage information associated with streaming the video to the user's device. In some implementations, the resource usage information is associated with a content delivery network (CDN) providing a streaming service to stream the video to the user's device from the system, and corresponds to the resource usage needed to stream a unit of video data from the system to the user's device. As shown in FIG. 2, the resource usage information can be an input to the resource usage module in FIG. 2.

At 210, the system determines a quality score associated with the user and the video using the quality module. The quality module determines the quality score for each video version (i.e., each resolution/bitrate pair for the video) according to a particular functional relationship that is based on the user portrait. The quality score indicates a measure of the perceived video quality by the user. The quality score can be based on the video resolution/bitrate. However, in some other implementations, the quality score can be based on other scoring techniques, for example, a video multimethod assessment fusion (VMAF) score. As shown in the quality module of FIG. 2, the functional relationship can be linear, logarithmic, or customized. In some implementations, if the preference of the user is video smoothness preferred, a logarithmic function can be used to decrease the contribution of higher resolution of a video to the determination of the quality score. If the preference of the user is video quality preferred, a linear function can be used to increase the contribution of higher resolution of a video to the determination of the quality score. In some implementations, the quality score has a value between 0 and 1.

At 212, the system determines a QoS penalty associated with the user and the video using the QoS/Smoothness module. The QoS penalty can be a weighted sum of a first frame penalty and a video stall penalty. In some implementations, the first frame penalty is associated with how long the user waits before the video starts playing based on each resolution/bitrate version of the video. For example, if the user's device buffers the initial portion of the video with length of video_duration at a given bitrate, before playing the video, the first frame penalty can be a normalized version of: video_duration*bitrate/network_speed, where the bitrate corresponds to the bitrate of each version of the video from the version information obtained at 202, and the network_speed corresponds to the bandwidth measurement of the user's network obtained at 206. Depending on the network speed, a higher bitrate version of the video can lead to larger first frame penalty. Similarly, the video stall penalty is associated with the buffer of the user's device being empty before the current video segment of the video has finished playing resulting in the video pausing or introducing other latency effects during playback, and is related to both the bitrate of the video streaming and the bandwidth of the user's network. In some implementations, the QoS penalty has a value between 0 and 1.

At 214, the system determines a resource usage penalty by running a resource usage module. The resource usage penalty can be based on one or more of the bitrate of the video version, the cache in the user's device used to buffer the video during streaming, or the duration of the video. The resource usage penalty can be independent of the preference of the user from the user portrait at 204. The resource usage penalty can represent the resource usage of a content delivery network (CDN) that streams the video from seethe system to the user's device.

At 216, the system determines a return of interest (ROI) score for each resolution/bitrate version of the video based on the quality score from 210, the QoS penalty from 212, and the resource usage penalty from 214. Equation 1 shows the determination of the ROI score:

ROI=w1*quality_score−w2*smoothness_score−w3*resource_usage (1)
where w1, w2, and w3 are three weighting factors, the quality_score represents the quality score from 210, the smoothness_score represents the QoS penalty from 212, and the resource usage represents the resource usage penalty from 214. In some cases, the sum of w1, w2, and w3 can equal to one.

At 218, the system selects the particular version of the video from the set of transcoded versions of the video, where the selected resolution corresponds to the largest ROI determined at 216, where the ROI's are based on the preference of the user from the user portrait at 204 as used in the determination of the quality score and the smoothness penalty components of the ROI calculation. The system can then provide the corresponding version of the video to the user device for playback.

Table 1 shows an example of how ROI scores of a user determined for two versions, one with a resolution of 1080p, and another one with a resolution of 720p, depending on the user preference indicated in the user portrait. For the video with a resolution of 1080p, the resource usage penalty from the resource usage module is 0.5, regardless of the preference of the user between video quality and video smoothness for video playback during video streaming. For the video with a resolution of 720p, the resource usage penalty from the resource usage module is 0.3, regardless of the preference of the user between video quality and video smoothness for video playback during video streaming. For example, the resource usage penalty may be lower for the 720p version due to a lower bitrate requiring less network resources to stream.

TABLE 1

| | 1080 p | | | | 720 p | | | | |
|---|---|---|---|---|---|---|---|---|---|
| | | | Resource | | | | Resource | | |
| | Quality | Smoothness | usage | | Quality | Smoothness | usage | | Resolution |
| | score | penalty | penalty | ROI | score | penalty | penalty | ROI | selected |
| Default | 0.8 | 0.3 | 0.5 | 0.7 | 0.5 | 0.2 | 0.3 | 0.62 | 1080 p |
| Quality | 0.9 | 0.3 | 0.5 | 0.75 | 0.45 | 0.2 | 0.3 | 0.6 | 1080 p |
| preferred | | | | | | | | | |
| Smoothness | 0.8 | 0.4 | 0.5 | 0.65 | 0.5 | 0.1 | 0.3 | 0.7 | 720 p |
| preferred | | | | | | | | | |

For the video with a resolution of 1080p, a default video quality score is 0.8 and a default video smoothness penalty is 0.3, when the user does not have a preference between video quality and video smoothness for video playback during video streaming (e.g., when the user preference in user portrait is 0.5), or when the user preference is unknown. Therefore, the default ROI can be determined to be 0.7 using Equation 1 and corresponding weighting factors w1, w2, and w3.

For the video with a resolution of 1080p, when the user portrait indicates that the user is video quality preferred (e.g., when the user preference in user portrait is 1), a quality score of 0.9 is determined by the quality module in FIG. 2, based on the video resolution of 1080p and a functional relationship used based on the indicated preference (e.g., a linear function, a logarithmic function, or a customized function in the quality module of FIG. 2), and a smoothness penalty (e.g., QoS penalty from the QoS/Smoothness module in FIG. 2) of 0.3 is determined by the QoS/Smoothness module in FIG. 2, based on the video resolution of 1080p, the network bandwidth/speed from 206 in FIG. 2, and the first frame penalty and/or the video stall penalty in the QoS/Smoothness module of FIG. 2.

Therefore, for the video with a resolution of 1080p, when the user portrait indicates that the user is video quality preferred, the overall ROI can be determined to be 0.75 using Equation 1 with corresponding weighting factors w1, w2, and w3.

Similarly, for the video with a resolution of 1080p, when the user portrait indicates that the user is video smoothness preferred (e.g., when the user preference in user portrait is 0), a quality score of 0.8 is determined by the quality module in FIG. 2, based on the video resolution of 1080p and a functional relationship used based on the indicated preference (e.g., a linear function, a logarithmic function, or a customized function in the quality module of FIG. 2), and a smoothness penalty of 0.4 is determined by the QoS/Smoothness module in FIG. 2, based on the video resolution of 1080p, the network bandwidth/speed from 206 in FIG. 2, and the first frame penalty and/or the video stall penalty in the QoS/Smoothness module of FIG. 2.

Therefore, for the video with a resolution of 1080p, when the user portrait indicates that the user is video smoothness preferred, the overall ROI can be determined to be 0.65 using Equation 1 with corresponding weighting factors w1, w2, and w3.

For the video with a resolution of 720p, a default video quality score is 0.5 and a default video smoothness penalty is 0.2, when the user does not have a preference between video quality and video smoothness for video playback during video streaming (e.g., when the user preference in user portrait is 0.5), or when the user preference is unknown. Therefore, the default ROI can be determined to be 0.62 using Equation 1 and corresponding weighting factors w1, w2, and w3.

For the video with a resolution of 720p, when the user portrait indicates that the user is video quality preferred (e.g., when the user preference in user portrait is 1), a quality score of 0.45 is determined by the quality module in FIG. 2, based on the video resolution of 720p and a functional relationship used based on the indicated preference (e.g., a linear function, a logarithmic function, or a customized function in the quality module of FIG. 2), and a smoothness penalty (e.g., QoS penalty from the QoS/Smoothness module in FIG. 2) of 0.2 is determined by the QoS/Smoothness module in FIG. 2, based on the video resolution of 720p, the network bandwidth/speed from 206 in FIG. 2, and the first frame penalty and/or the video stall penalty in the QoS/Smoothness module of FIG. 2.

Therefore, for the video with a resolution of 720p, when the user portrait indicates that the user is video quality preferred, the overall ROI can be determined to be 0.6 using Equation 1 with corresponding weighting factors w1, w2, and w3.

Similarly, for the video with a resolution of 720p, when the user portrait indicates that the user is video smoothness preferred (e.g., when the user preference in user portrait is 0), a quality score of 0.5 is determined by the quality module in FIG. 2, based on the video resolution of 720p and a functional relationship used based on the indicated preference (e.g., a linear function, a logarithmic function, or a customized function in the quality module of FIG. 2), and a smoothness penalty of 0.1 is determined by the QoS/Smoothness module in FIG. 2, based on the video resolution of 720p, the network bandwidth/speed from 206 in FIG. 2, and the first frame penalty and/or the video stall penalty in the QoS/Smoothness module of FIG. 2.

Therefore, for the video with a resolution of 720p, when the user portrait indicates that the user is video smoothness preferred, the overall ROI can be determined to be 0.7 using Equation 1 with corresponding weighting factors w1, w2, and w3.

Consequently, based on the overall ROIs determined above for difference cases, when the user portrait indicates that the user is video quality preferred, the video with a resolution of 1080p can be selected at 218 in FIG. 2 for video playback during video streaming as having the highest ROI given that preference. When the user portrait indicates that the user is video smoothness preferred, the video with a resolution of 720p is selected at 218 in FIG. 2 for video playback during video streaming as having the highest ROI given that preference. Consequently, the system can select the version of the video to provided that takes into account the user preference.

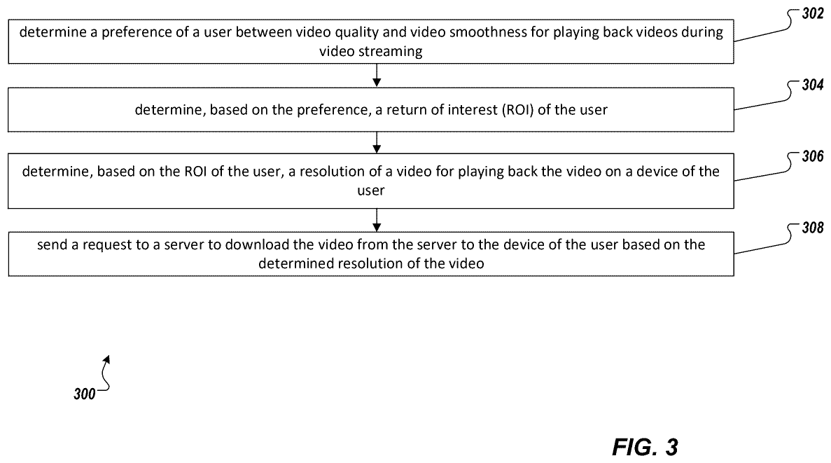

FIG. 3 illustrates an example process 300 of determining video resolution for video streaming. For convenience, the process 300 will be described as being performed by a system of one or more computers, located in one or more locations, and programmed appropriately in accordance with this specification. For example, a streaming system, e.g., an online social media platform, appropriately programmed, can perform the process 300.

At 302, a system determines a preference of a user between video quality and video smoothness for playing back videos during video streaming. The system can determine the user's preference offline at some time prior to a current video streaming session based, for example, on the user's historical playback history.

At 304, the system determines, based on the preference, a return of interest (ROI) of the user for each version of a particular video.

At 306, the system determines, based on the ROI of the user, a version of the video, e.g., a version having a particular resolution and bitrate, to provide to a user device for playback.

At 308, the system provides the determined version of the video to the user device.

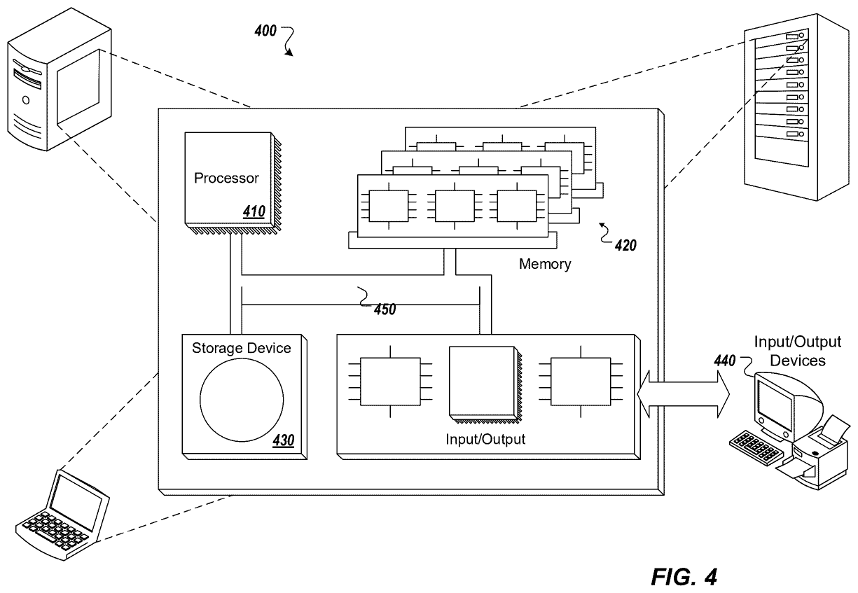

FIG. 4 illustrates a schematic diagram of an example computing system 400. The system 400 can be used for the operations described in association with the implementations described in this specification. For example, the system 400 may be included in any or all of the server components discussed above. The system 400 includes a processor 410, a memory 420, a storage device 430, and an input/output device 440. The components 410, 420, 430, and 440 are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is one or more computer-readable media. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

In addition to the embodiments of the attached claims and the embodiments described above, the following embodiments are also innovative:

Embodiment 1 is a computer-implemented method comprising: determining a preference of a user for a particular video playback characteristic; determining, based on the determined preference of the user and for each version of a video, a return of interest (ROI), wherein each version of the video has a particular resolution and bitrate; determining, based on the ROI, a version of the video to provide to a device of the user; and providing the corresponding version of the video to the device of the user.

Embodiment 2 is the computer-implemented method of embodiment 1, wherein the preference of the user comprises one of a video quality preference of the user and a video smoothness preference of the user.

Embodiment 3 is the computer-implemented method of any one of embodiments 1 through 2, wherein the providing the version of the video is associated with of a content delivery network (CDN) of a video streaming system.

Embodiment 4 is the computer-implemented method of any one of embodiments 1 through 3, wherein determining the ROI of a particular version of the video comprises: determining a quality score for the version of the video based on the determined preference of the user; determining a smoothness penalty for the version of the video based on the determined preference of the user; and determining the ROI based on a combination of the quality score and the smoothness penalty.

Embodiment 5 is the computer-implemented method of any one of embodiments 1 through 4, wherein determining the ROI comprises: determining a resource usage penalty associated with the CDN for transcoding the video and sending the video from the system to the device of the user; and determining the ROI based on a combination of the quality score, the smoothness penalty, and the resource usage penalty.

Embodiment 6 is the computer-implemented method of any one of embodiments 1 through 5, wherein determining the quality score comprises determining the quality score based on a linear function or a logarithmic function selected based on the determined user preference and characteristics of the version of the video.

Embodiment 7 is the computer-implemented method of any one of embodiments 1 through 6, wherein determining the smoothness penalty comprises determining the smoothness penalty based on the determined user preference and at least one of a wait time before a first frame of the video is played back or a quantity of rebufferings or stalls of the video during a predetermined period of time.

Embodiment 8 is the computer-implemented method of any one of embodiments 1 through 7, wherein determining the preference of the user comprises determining the preference of the user based on a video playback history of the user.

Embodiment 9 is a system comprising: one or more computers and one or more storage devices storing instructions that are operable, when executed by the one or more computers, to cause the one or more computers to perform the method of any one of embodiments to 8.

Embodiment 10 is a computer storage medium encoded with a computer program, the program comprising instructions that are operable, when executed by data processing apparatus, to cause the data processing apparatus to perform the method of any one of embodiments 1 to 8.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method comprising:
determining a preference of a user for a particular video playback characteristic;
determining, based on the determined preference of the user and for each version of a video, a return of interest (ROI), wherein each version of the video has a particular resolution and bitrate;
determining, based on the ROI, a version of the video to provide to a device of the user; and
providing the corresponding version of the video to the device of the user.

2. The computer-implemented method of claim 1, wherein the preference of the user comprises one of a video quality preference of the user and a video smoothness preference of the user.

3. The computer-implemented method of claim 2, wherein the providing the version of the video is associated with of a content delivery network (CDN) of a video streaming system.

4. The computer-implemented method of claim 3, wherein determining the ROI of a particular version of the video comprises:
determining a quality score for the version of the video based on the determined preference of the user;
determining a smoothness penalty for the version of the video based on the determined preference of the user; and
determining the ROI based on a combination of the quality score and the smoothness penalty.

5. The computer-implemented method of claim 4, wherein determining the ROI comprises:
determining a resource usage penalty associated with the CDN for transcoding the video and sending the video from the system to the device of the user; and
determining the ROI based on a combination of the quality score, the smoothness penalty, and the resource usage penalty.

6. The computer-implemented method of claim 4, wherein determining the quality score comprises determining the quality score based on a linear function or a logarithmic function selected based on the determined user preference and characteristics of the version of the video.

7. The computer-implemented method of claim 4, wherein determining the smoothness penalty comprises determining the smoothness penalty based on the determined user preference and at least one of a wait time before a first frame of the video is played back or a quantity of rebufferings or stalls of the video during a predetermined period of time.

8. The computer-implemented method of claim 1, wherein determining the preference of the user comprises determining the preference of the user based on a video playback history of the user.

9. A system comprising:
one or more computers and one or more storage devices storing instructions that are operable, when executed by the one or more computers, to cause the one or more computers to perform operations comprising:
determining a preference of a user for a particular video playback characteristic;
determining, based on the determined preference of the user and for each version of a video, a return of interest (ROI), wherein each version of the video has a particular resolution and bitrate;
determining, based on the ROI, a version of the video to provide to a device of the user; and
providing the corresponding version of the video to the device of the user.

10. The system of claim 9, wherein the preference of the user comprises one of a video quality preference of the user and a video smoothness preference of the user.

11. The system of claim 10, wherein the providing the version of the video is associated with of a content delivery network (CDN) of a video streaming system.

12. The system of claim 11, wherein determining the ROI of a particular version of the video comprises:
determining a quality score for the version of the video based on the determined preference of the user;
determining a smoothness penalty for the version of the video based on the determined preference of the user; and
determining the ROI based on a combination of the quality score and the smoothness penalty.

13. The system of claim 12, wherein determining the ROI comprises:
determining a resource usage penalty associated with the CDN for transcoding the video and sending the video from the system to the device of the user; and
determining the ROI based on a combination of the quality score, the smoothness penalty, and the resource usage penalty.

14. The system of claim 12, wherein determining the quality score comprises determining the quality score based on a linear function or a logarithmic function selected based on the determined user preference and characteristics of the version of the video.

15. The system of claim 12, wherein determining the smoothness penalty comprises determining the smoothness penalty based on the determined user preference and at least one of a wait time before a first frame of the video is played back or a quantity of rebufferings or stalls of the video during a predetermined period of time.

16. The system of claim 9, wherein determining the preference of the user comprises determining the preference of the user based on a video playback history of the user.

17. One or more computer-readable storage media encoded with instructions that, when executed by one or more computers, cause the one or more computers to perform operations comprising:
determining a preference of a user for a particular video playback characteristic;
determining, based on the determined preference of the user and for each version of a video, a return of interest (ROI), wherein each version of the video has a particular resolution and bitrate;
determining, based on the ROI, a version of the video to provide to a device of the user; and
providing the corresponding version of the video to the device of the user.

18. The computer-readable storage media of claim 17, wherein the preference of the user comprises one of a video quality preference of the user and a video smoothness preference of the user.

19. The computer-readable storage media of claim 18, wherein the providing the version of the video is associated with of a content delivery network (CDN) of a video streaming system.

20. The computer-readable storage media of claim 19, wherein determining the ROI of a particular version of the video comprises:
determining a quality score for the version of the video based on the determined preference of the user;
determining a smoothness penalty for the version of the video based on the determined preference of the user; and
determining the ROI based on a combination of the quality score and the smoothness penalty.
